(19) United States
(12) Patent Application Publication
(10) Pub. No.: US 2004/0211109 A1
(43) Pub. Date: Oct. 28, 2004

(54) Apparatus and methods for tying flies

(76) Inventor: Marc Petitjean, Fribourg (CH)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/831,603

(22) Filed: Apr. 22, 2004

Related U.S. Application Data
(60) Provisional application No. 60/561,927, filed on Apr. 14, 2004.

(30) Foreign Application Priority Data
Apr. 24, 2003 (CH) 2003 0729/03

(51) Int. Cl. A01K 85/00

(52) U.S. Cl. 43/42.25; 43/42

(57) ABSTRACT

Fly-tying apparatus include at least a retractable clamp table and a retractable gripping clamp, each configured for handling delicate threads for use in creating fishing lures. In particular, fly-tying materials (e.g., hackle, dubbing, synthetic materials, etc.) can be inserted into a retractable slot in the clamp table, and can be removed from the clamp table using the gripping clamp. The gripping clamp can be used to hold the materials while being processed (e.g., removing a stem from a feather), and for attaching the fly-tying materials to a tying thread. Cylindrical tools are also provided for further processing more fine strands such as synthetic threaded materials, and for adding these with other fly-tying materials (e.g., hackle, dubbing), as appropriate.

### CROSS-REFERENCE TO RELATED APPLICATIONS

This application claims the benefit of priority to Swiss Patent Application No. 2003 0729/03, filed in the Swiss Federal Institute of Intellectual Property on Apr. 24, 2003, entitled “MONTAGE DE MOUCHES ARTIFICIELLES POUR LA PECHE” (“ASSEMBLY OF ARTIFICIAL FLIES FOR FISHING”); and claims the benefit of priority to U.S. Provisional Patent Application Ser. No. 60/561,927, filed on Apr. 14, 2004, entitled “FLY TYING DEVICE”. The contents of each of the aforementioned applications are incorporated herein by reference in their entirety.

### BACKGROUND OF THE INVENTION

1. The Field of the Invention

This invention relates to systems, apparatus and methods for tying flies for use in fly-fishing.

2. Background and Relevant Art

In tying artificial flies for fly fishing, fly-tiers look for more and more sophisticated mixtures of fly-tying materials in order to effect a certain color, texture, volume, aerodynamic property, and hydrodynamic property in a given fly. As such, fly-tiers often have large quantities of miscellaneous natural and synthetic materials available for creating a wide variety of flies for luring fish. These materials generally include different colored natural or synthetic feathers from different fowl (e.g., roosters, ducks, turkeys, partridge, etc.), as well as similarly-variable dubbing, and related materials (e.g., textile threads).

Unfortunately, it can be fairly difficult to mix the wide variety of available synthetic and natural materials together to create a desired fly. For example, it is fairly difficult to remove thin feather strands from a feather stem, and then combine the removed feather strands with other fly-tying materials without dropping or misplacing some of the smaller materials. In particular, the other fly-tying materials (e.g., dubbing, fine synthetic threads, etc.) may also be as difficult to grip as the feather strands, particularly when trying to combine the various materials around the fly hook.

Similarly, different types of materials can be of varying grades of stiffness, thickness (or thinness), fragility, and so forth. As such, mixing these various different materials to make a desired fly can be fairly complicated, and often requires multiple procedures, which are often difficult and time consuming, and sometimes even impossible to perform depending on the material.

Accordingly, an advantage in the art can be realized with systems, apparatus, and methods that allow various fly-tiers to handle fly-tying materials easily so that the fly-tying materials can be positioned easily around a hook as desired. Ideally, apparatus for handling such materials should be simple to use, and inexpensive.

### BRIEF SUMMARY OF THE INVENTION

The present invention solves one or more of the foregoing problems in the art with systems, apparatus, and methods that allow a user to easily grip and handle a wide variety of fly-tying materials.

In at least one exemplary implementation, a user places one or more fly-tying materials inside a retractable slot of a clamp table. At least a portion of the combined materials is exposed outside of the retractable slot of the clamp table, such that the exposed portions can later be gripped by a gripping clamp. A user then grips the exposed portions of the combined materials with the gripping clamp, and removes the combined materials from the clamp table. Afterward, the user can process the combined materials in the gripping clamp so that the combined materials can be transferred from the gripping clamp to a tying thread. After the user has transferred the processed materials to the tying thread, the user can then wrap the tying thread around a hook, as appropriate, so that the hook resembles a desired fly.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an overview depiction of an unassembled clamp table without an elastic element in accordance with an implementation of the present invention;

FIG. 1B illustrates an assembled clamp table in accordance with an implementation of the present invention;

FIG. 1C illustrates an overview depiction of an unassembled gripping clamp in accordance with an implementation of the present invention;

FIG. 1D illustrates an assembled gripping clamp in accordance with an implementation of the present invention;

FIG. 1E illustrates an alternative exemplary configuration of a clamp table in accordance with an implementation of the present invention;

FIG. 1F illustrates yet another alternative exemplary configuration of a clamp table in accordance with an implementation of the present invention;

FIGS. 2A-2E illustrate an exemplary sequence for transferring fly-tying materials between clamps, and for processing fly-tying materials in accordance with an implementation of the present invention;

FIG. 3A-3E illustrate an exemplary sequence for transferring processed fly-tying materials to a tying thread in accordance with an implementation of the present invention;

FIG. 4A-4E illustrate an alternative exemplary sequence for adding multiple fly-tying materials to a clamp table using a wooden dowel in accordance with an implementation of the present invention; and

FIGS. 5A-5D illustrate yet another alternative exemplary sequence for adding multiple fly-tying materials to an alternative exemplary embody of a clamp table, and for transferring fly-tying materials between clamps.

### DETAILED DESCRIPTION OF THE PREFERRED EMBODIMENTS

The present invention extends to systems, apparatus, and methods that allow a user to easily grip and handle a wide variety of fly-tying materials. In particular, exemplary implementations of the present invention allow a fly-tier to combine natural and synthetic hackle with natural or synthetic dubbing (and related materials), to create a desired fishing lure.

By way of explanation, exemplary implementations of the present invention are described herein with some reference to terms that are common in the fly-tying art. For example, the term “hackle” refers to feathers commonly found on the saddle or neck of a fowl. The term “CDC” refers to a type of feather called “Cul de Canard”, and refers to a particular type of feather found on the rear of a water fowl, such as the rear of a duck. CDC is a particularly useful type of feather in fishing lures since its strands are buoyant, resistant to water, and insect-like. The term “dubbing” refers to a type of filler material, somewhat resembling cotton, wool, or animal fur, that can be wound around a fly hook to give the hook a natural body appearance, such as to appear as the thorax of an insect. Dubbing is a fairly broad term that encompasses many types of fibrous stuffing materials.

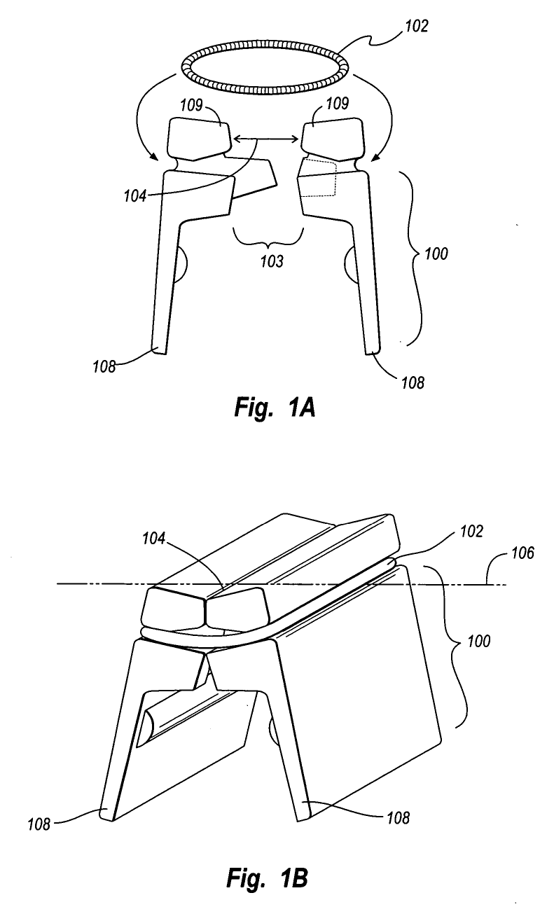

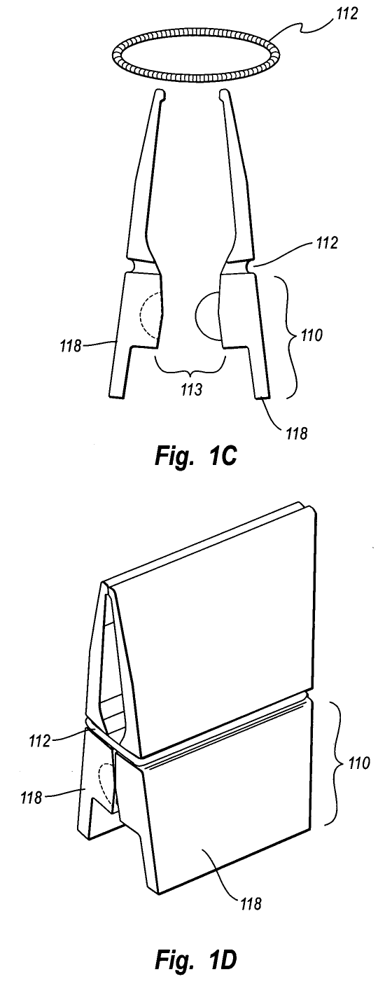

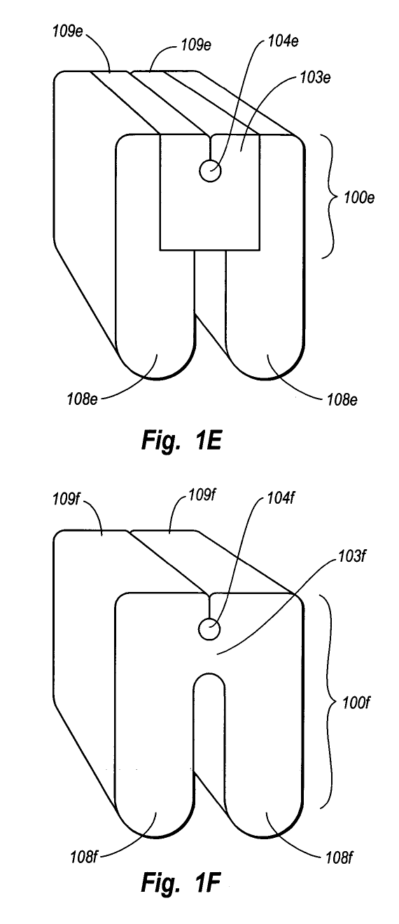

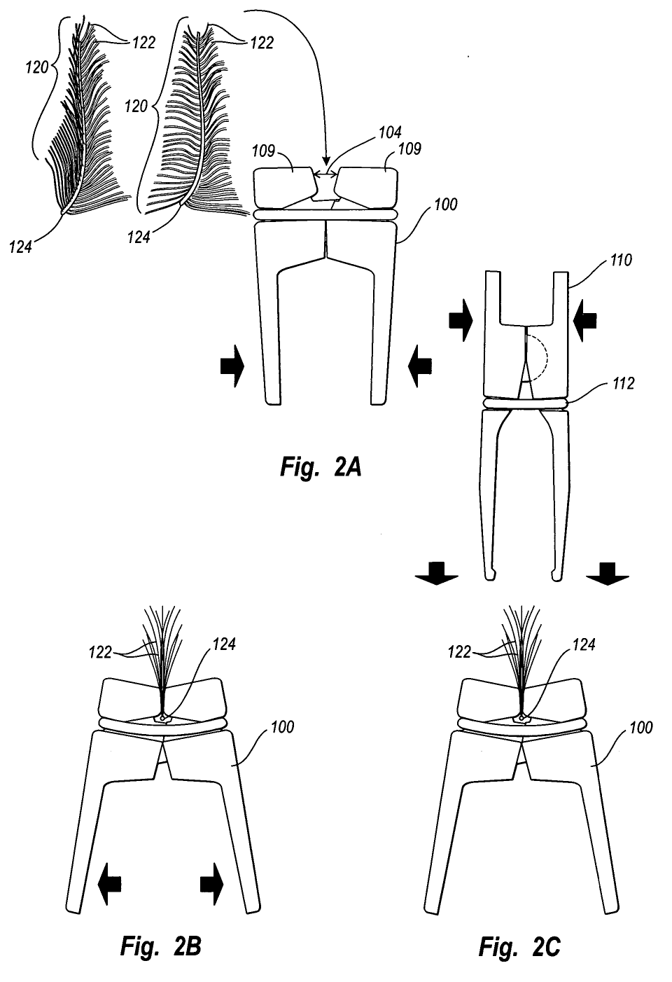

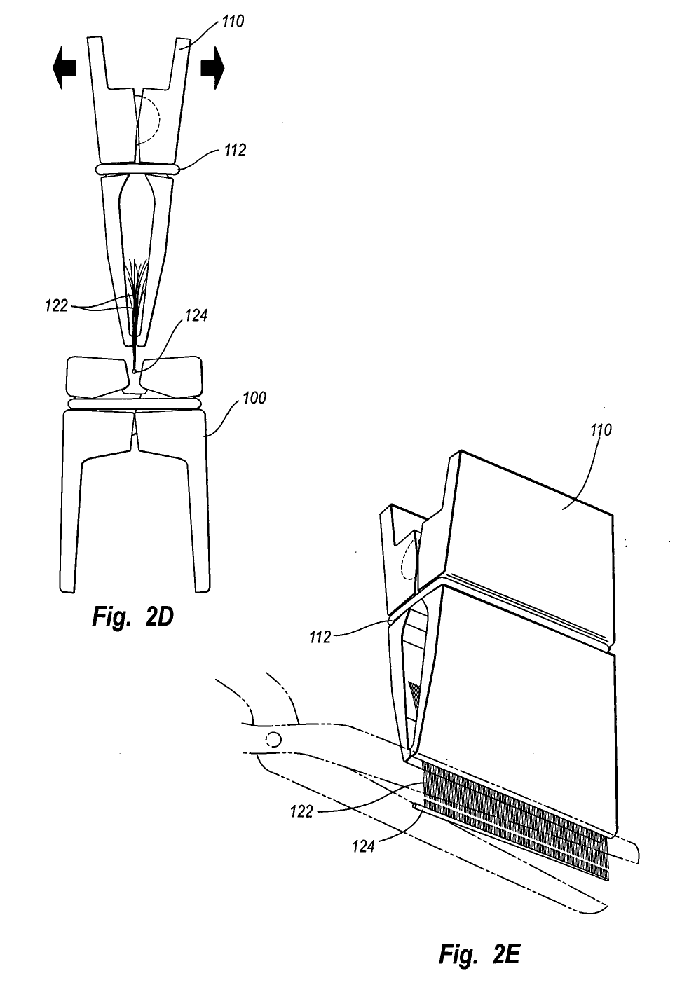

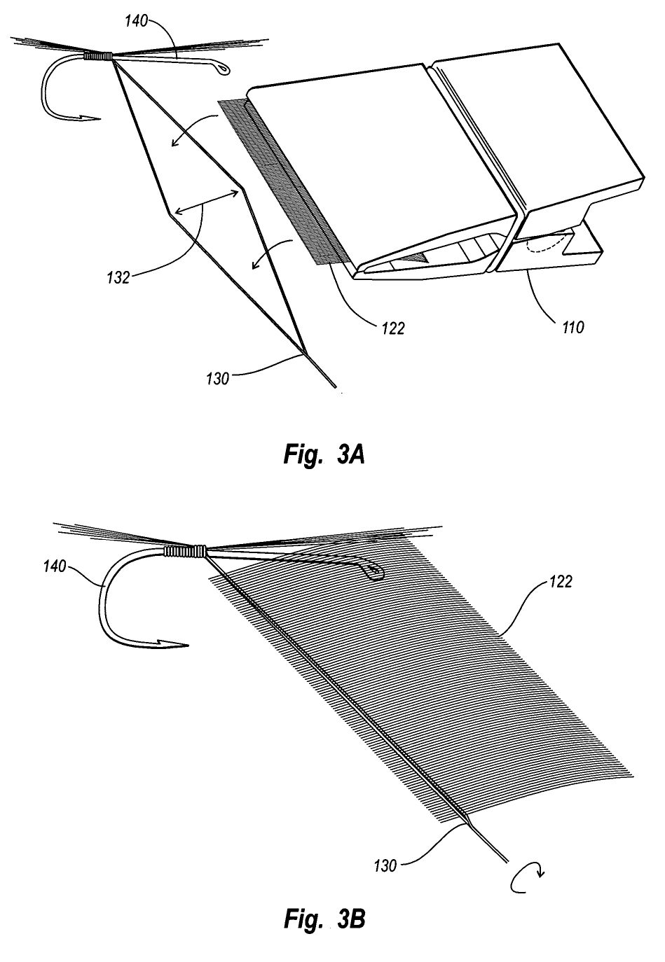

FIGS. 1A and 1B illustrate an assembly sequence for a retractable “clamp table” 100. As will be understood from this specification and claims, a retractable “clamp table” can be formed in a wide variety of shapes, sizes, and configurations. At least one common property between different types of clamp tables is that the clamp table should be able to rest on a work surface. This can mean that the clamp table has two or more stable elements (e.g., legs) that are capable of supporting the clamp table on the work surface, or alternatively that the clamp table comprises a substantially flat lower surface (see, e.g., resilient member 103e, FIG. 1E, which can be used by itself). Exemplary implementations of the “clamp table” will also be understood to comprise generally a substantially (or approximately) planar upper working surface having a retractable gap or slot formed inside, in which fly-tying materials can be positioned.

FIG. 1A, for example, depicts one exemplary such retractable clamp table 100, which comprises a pair of first and second elements 108 that are hinged together about a pivot 103. The elements 108 can be formed to include a generally elongate leg portion that terminates in a gripping portion 109. In at least one implementation, a roller can be positioned between the gripping portions 109 of both the first and second elements 108 to allow ready insertion of fly-tying materials between the gripping portions 109. In any case, when a resilient member such as an elastic restraint (e.g., restraint 102) is absent from (or tensioned on) the clamp table 100, a relatively horizontal plane 106 is apparent on top of the clamp table, which makes the clamp table a useful work surface for handling small materials. One will appreciate, however, that there may be many types of restraint means including a spring bias positioned about, or between, the elements 108.

In any case, a retractable or resilient gap 104 exists between the first and second elements 108 of the clamp table. (The “retractable gap” is also sometime referred to herein as a “retractable slot”, or an “upper slit”). By contrast, as in FIG. 1B, when the elastic restraint 102 fits around a groove in the clamp table 100, the elements 108 move a degree about the pivot, and close the gap 104 such that the gripping portions 109 are closed in, or adjacent each other. In at least one implementation of the present invention, the elastic restraint 102 is somewhat loose, such that the elements 108 and gripping portions 109 of the clamp table can be opened and shut with relative ease.

As shown in FIGS. 1C and 1D, a similar mechanism can be used with the retractable gripping clamp 110, as shown in FIG. 1B. In particular, FIG. 1C shows that a retractable gripping clamp 110 comprises a pair of elements 118 hinged about a pivot 113. FIG. 1D shows that when an elastic restraint (e.g., restraint 112) fits around a corresponding groove in the gripping clamp 110, the gripping clamp 110 shuts to a relaxed, or closed position. One will appreciate, however, that there may be many types of restraint means including a spring bias positioned about, or between, the elements 118. In at least one implementation of the present invention, the elastic restraint 112 is somewhat loose, such that the elements 118 of the gripping clamp 110 can be opened and shut with relative ease.

Furthermore, the gripping clamp 110 and clamp table 100 comprise materials and designs that can help with the fly-tying process. For example, the gripping clamp 110 and clamp table 100 are typically shaped differently from each other, such that the gripping clamp 110 is suitable for gripping elongate strands, which extend out of the gap 104 in the clamp table 100. In particular, FIG. 1D shows that the gripping clamp 110 forms a roughly triangular point when the elastic restraint means are relaxed. By contrast, the clamp table 100 is particularly shaped to rest materials on an upper surface (e.g., plane 106) while the elements 108 rest on a separate work surface, such as the fly-tier's table.

Furthermore, the clamp table 100 and gripping clamp 110 can comprise translucent or transparent materials (e.g., plastic), which can help the fly-tier identify small or lightly colored materials positioned about, or within, each given clamp 100, and 110. Alternatively, the clamp table 100 and gripping clamp 110 can comprise colored materials configured for a similar purpose—identifying small and difficult to see fly-tying materials.

FIGS. 1E and 1F illustrate alternative implementations of a clamp table as exemplified by clamp table 100 in FIGS. 1A and 1B. In particular, an exemplary clamp table 100e can further comprise more simple construction materials such as elements 108e fixed together by a slotted (e.g., retractable groove 104e) pivoting member 103e (also referred to herein as a “resilient member”). In at least one implementation, the slotted pivoting member 103e comprises the gripping surfaces 109e, and is flexible enough that the groove 103e can spread sufficiently with relative ease as fly-tying materials are inserted into retractable groove 104e. In yet another implementation, the slotted pivoting (or resilient) member 103e can be used by itself without elements 108e, particularly when the pivoting (or resilient) member 103e comprises a sufficiently flexible material such as foam rubber, or similarly flexible or resilient materials. In still a further implementation, the resilient member 103e comprises at least one roller (not shown), positioned inside to aid insertion of fly-tying materials.

FIG. 1F shows that an exemplary clamp table 104f can also comprise a single, flexible material having elements 108f, gripping surface 109f, and a retractable slot or groove 104f formed therein. Both of the exemplary clamp tables 110e and 100f can comprise primarily flexible materials such as foam rubber, flexible plastic, and other similarly flexible and/or resilient materials in which a retractable slot or groove (e.g., 104, 104e, 104f, 104g, etc.) can be formed. Preferably, the resilient members 103e, 103f, are configured such that fly-tying materials can be selectively maintained between the gripping portions (e.g., 109e, 109f), and such that a user can release the fly-tying materials by moving the first and second elements (e.g., 108e, 108f) closer together.

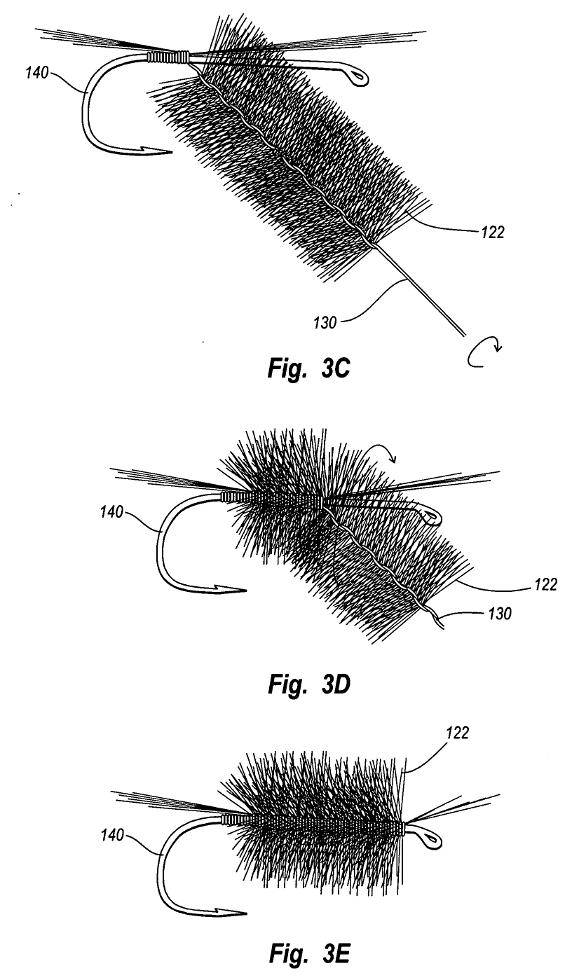

FIGS. 2A-2E illustrate an exemplary sequence in accordance with the present invention for processing one or more fly-tying materials (e.g., 120), such as hackle, CDC, etc. With respect to using hackle 120, for example, a fly-tier places hackle 120 inside a “retractable (or expandable) slot”, via retractable (or expandable) gap 104, in a clamp table 100. As shown in FIG. 2A, the fly-tier places the hackle 120 in such a way that the entire hackle stem 124 is at the lowest point in the gap 104, with the hackle strands 122 extending upward out of gap 104. Preferably, the fly-tier also ruffles the strands 122 of the hackle 120 in a reverse direction prior to inserting the hackle 120 into gap 104. As such, strands 122 extend upward out of the clamp table 100 (see FIG. 2B) at 90° relative to the hackle stem 124. In any case, at least a portion 122 of the hackle 120 is exposed outside of the clamp table's 100 expandable slot, such that the exposed portions 122 can be gripped by gripping clamp 110.

As shown in FIG. 2C, a fly-tier then positions the gripping clamp 110 over the exposed portions of strands 122, and grips the exposed portions with the gripping clamp 110. The fly-tier then removes the materials (FIG. 2D) from the clamp table 100, and processes the materials (FIG. 2E). With respect to hackle 120, for example, “processing” implies at least removing the stem 124 of the hackle 120 from the strands 122. This can be done by any number of means, including snipping off the strands 122 using simple cutting tools, such as scissors. Alternatively, other means of processing can imply trimming the gripped materials so that they are aligned for subsequent operations.

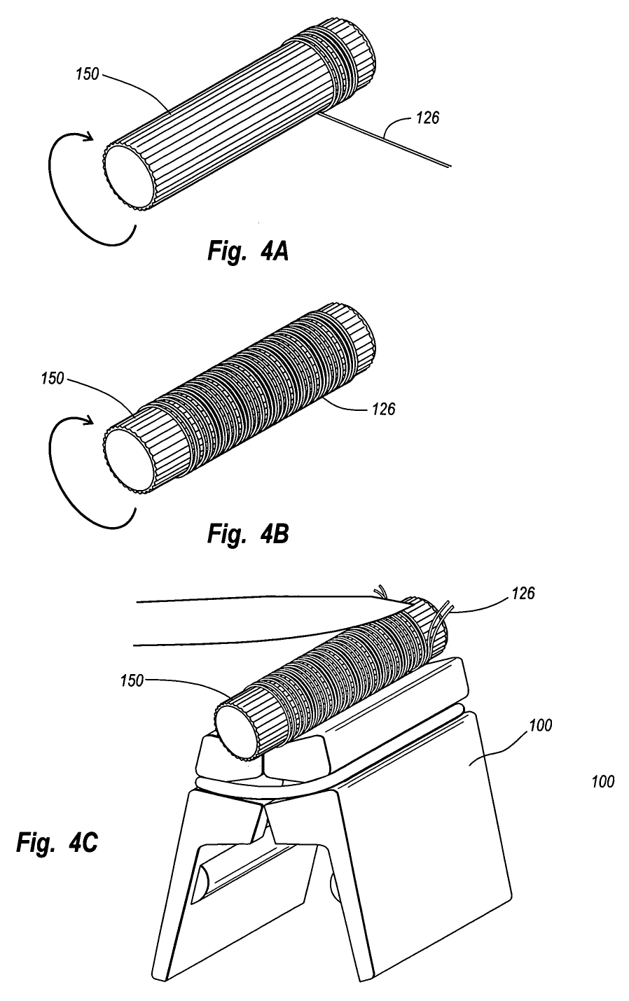

In particular, FIGS. 3A-3E illustrate an exemplary sequence for subsequent operations that include applying fly-tying materials, such as hackle 120, to a tying thread 130. For example, as shown in FIG. 3A, a fly-tier can split a tying thread 130 so that the tying thread 130 forms a gap 132 at one point, and opposing in-tact portions along the length of the tying thread 130. The fly-tier then positions the exposed strands 122 within the gap 132, using the gripping clamp 110 (FIG. 3A), and pulls the tying thread 130 tight so that the strands 122 stay in the gap 132 (FIG. 3B). The fly-tier then tensions the gripping clamp 110 so that the clamp releases the strands 122. As shown in FIG. 3B, therefore, the strands 122 should extend substantially perpendicular to the tying thread 130.

In the attached configuration shown in FIG. 3B, the fly-tier can then twist the tying thread 130 so that the strands 122 begin to extend from the tying thread 130 in a random fashion (FIG. 3C). The strands 122 (or other related materials) can then be rotated about the hook 140 (FIGS. 3D and 3E), so that the materials (e.g., hackle strands 122, etc.) begin to form a lure body, having outward extending strands 122.

One will, of course, appreciate that the invention is not limited to applying only hackle 120 to a lure 140. In particular, the previously described steps can be repeated with other types of material such as fibrous dubbing, or elongate synthetic fibers and the like. For example, rather than hackle 120, a user could place a clump of dubbing material (not shown) on the clamp table surface 106, and wedge the dubbing material into the gap 104 using, for example, a wire (not shown). Upon removing the wire from the gap 104, exposed portions of the clump of dubbing material can be gripped by the gripping clamp 110, and then snipped to fit into tying thread 130 gap 132. Accordingly, the previously described apparatus and steps can be applied to a wide variety of materials.

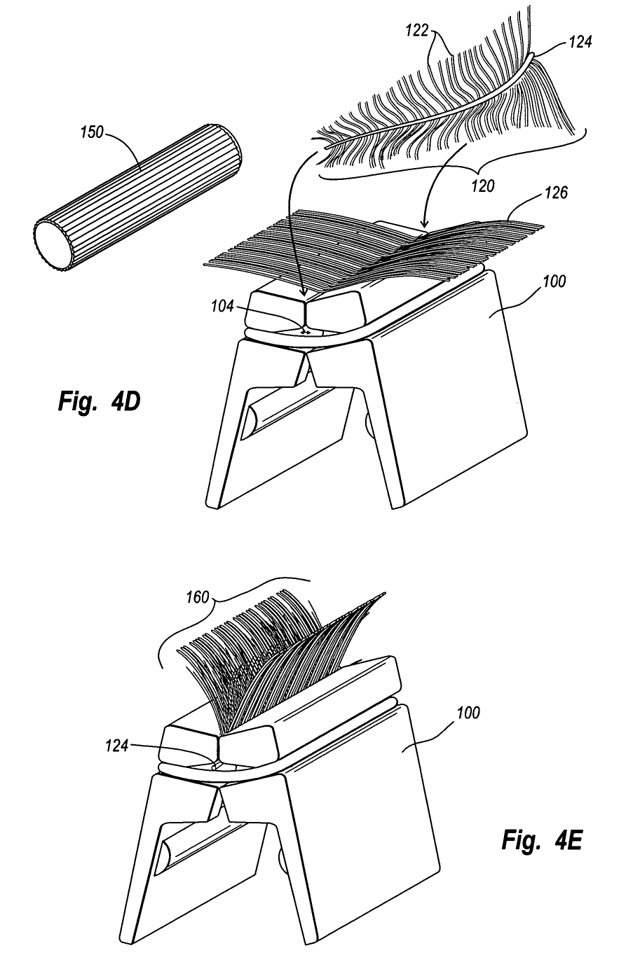

FIGS. 4A-4E illustrate yet an additional exemplary embodiment for combining elongate synthetic fibers 126 with hackle 120, prior to processing the materials (e.g. FIG. 3E). As shown in FIG. 4A, for example, a fly-tier can wrap synthetic fiber 126 about a wrapping cylinder 150, such as a wooden dowel. After several lengths of synthetic fiber 126 have been wrapped around the cylinder 150 (FIG. 4B), the fly-tier places the cylinder 150 on the upper surface (e.g., 106) of clamp table 100 (FIG. 4C). In this position, the user can then cut across the wrapping cylinder 150, so that the synthetic fiber 126 lays flat across the top of the clamp table 100.

To place the synthetic fiber materials inside the clamp table 100, the fly-tier can place the hackle 120 stem 124 on top of the synthetic fiber 126 (FIG. 4D), and position both the hackle 120 and synthetic fiber 126 into the gap 104, via the expandable slot (compare with FIG. 2A). Alternatively, as previously described, the fly-tier can pull a thread (e.g., a small metal wire) through the gap 104 and remove the wire, thus leaving the synthetic fiber inside the clamp table 100 gap 104. Thus, in at least one implementation, the elastic restraint 102 is loose enough that the fly-tier can simply wedge the combined materials (e.g., hackle 120 and synthetic fiber 126) into the gap 104 without separately having to squeeze the clamp elements 108 together with other help. With the combined materials now in the appropriate position, the materials can be gripped by the gripping clamp 110, and removed (e.g., FIG. 2D), and processed. As with hackle 120, processing may comprise snipping with scissors, such as by cutting loops in the synthetic fiber 126, as well as removing any hackle 120 stem 124, if appropriate (e.g., FIG. 2E).

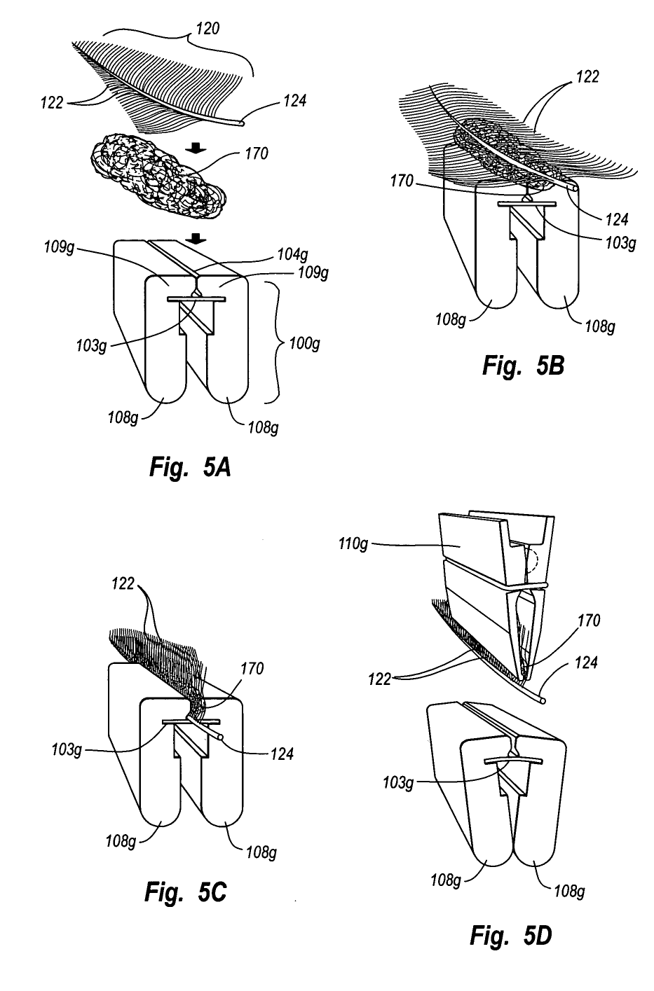

FIGS. 5A-5D illustrate yet another alternative exemplary sequence for processing hackle 120, this time with dubbing 170. FIGS. 5A-5D also illustrate the exemplary sequence using yet another alternative exemplary clamp table 100g, and using an alternative gripping clamp 110g. In particular, FIG. 5A shows an alternative clamp table 108g can comprise two elements 108g fixed about an alternative implementation of a resilient member 103g. As with the preceding figures, the elements 108g can comprise any flexible or resilient materials such as plastics, rubber, foam, and so forth. Furthermore, the resilient member 103g can comprise any biased element such as a plastic or metal “U-shaped” spring or plate member.

As further shown in FIG. 5A, a fly-tier can place dubbing 170 against an upper surface of the gripping members 109g, such that the dubbing 170 is placed above an upper slit 104g, such as a retractable gap that terminates in a larger recess or gap adjacent the resilient member 103g. The fly-tier can then take an elongate member, such as thread held by both hands, or take a similarly held hackle 120, as shown, and place it on top of the dubbing 170. As shown in FIG. 5B, the fly-tier can then wedge the hackle 120 into the upper slit 104g down toward the bottom of the upper slit 104g (or the larger gap portion). This wedges both the hackle 120 and the dubbing 170 into the retractable slot.

As shown in FIG. 5C, the portions of both the dubbing 170 and the hackle strands 122 are then exposed. In this position, as shown in FIG. 5D, the fly-tier can then grip the exposed portions of the hackle 120 and dubbing 170 with the gripping clamp 110g. The fly-tier can also compress the elements 108g such that the upper slit 104g opens, and allows the fly-tier to remove the fly-tying materials from the clamp table 100g. With the combined fly-tying materials now in the appropriate position, the materials can be processed (e.g., FIG. 2D). As before, processing may comprise snipping the fly-tying materials with scissors, such as by trimming the dubbing 170, as well as removing the hackle 120 stem 124 (e.g., FIG. 2E).

An advantage in the art can also be realized by providing the foregoing apparatus and materials in a fly-tying kit (not shown) for distribution among fly-tiers of a wide range of ability. For example, a fly-tying kit may include only one or more clamp tables 100, and one or more gripping clamps 110, and some form of instructional material. In at least one implementation of an exemplary fly-tying kit, clamp tables 100 having various sizes are provided with multiple correspondingly-sized gripping clamps 110. Similarly, the fly-tying kit may also be packaged with one or more wrapping cylinders 150. For example, wrapping cylinders 150 of different sizes can be provided to correspond with varyingly-sized clamp tables 100 and gripping clamps 110.

Of course, the fly-tying kit can also be packaged with one or more fly-tying materials for less experienced fly-tiers. For example, the fly-tying kit can include at least one of hackle, dubbing, synthetic fibers, tying thread, one or more hooks, and processing materials (e.g., scissors). Furthermore, an exemplary fly-tying kit can be packaged with instructional materials, such as at least one of instructional print media such as an instructional brochure, and instructional optical media such as an instructional CD-ROM, or an instructional DVD. As such, a fly-tying kit can be provided to significantly aid fly-tiers of a wide range of abilities, such that a wide range of fly-tiers can readily make any fly, however complex.

The present invention, therefore, provides novel apparatus, methods and instructions for gripping, processing, and combining delicate and sturdy materials for use in fly-tying. One will appreciate that a wide variety of materials can be used with the present invention. In particular, depending on the type of fly desired, the materials may or may not include hackle, may or may not include dubbing, or may or may not include related synthetic materials. Moreover, implementations of the present invention are amply suited for a wide variety of fly-tying materials, such as a wide-variety of shapes, colors, textures, and so forth. Thus, there are an almost infinite numbers of combinations possible for combining fly-tying materials to resemble an almost infinite number of flies.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. A system for tying flies for use in fly-fishing comprising:
a retractable clamp table comprising a retractable slot, wherein the retractable slot is configured to open sufficient to receive one or more fly-tying materials; and
a retractable gripping clamp, the retractable gripping clamp configured to grip an exposed portion of the one or more fly tying materials, which have been received inside the retractable slot.

2. The system as recited in claim 1, wherein the retractable slot is configured to open sufficient to receive one or more fly-tying materials when the fly-tying materials are wedged inside the retractable slot using any of a thread held at two ends, and a feather stem.

3. The system as recited in claim 1, wherein the retractable clamp table comprises a plurality of elements hingedly positioned about a pivot, such that the plurality of elements move about the pivot when retracting.

4. The system as recited in claim 3, further comprising an elastic restraint positioned about the clamp table, such that the clamp table is in a substantially closed position when the elastic restraint is relaxed.

5. The system as recited in claim 1, wherein the retractable clamp table comprises a single unit formed from a foam rubber material, such that the clamp table comprises a plurality of flexible elements formed about the retractable slot, and wherein the retractable slot resiliently spreads apart as fly-tying materials are wedged inside the retractable slot.

6. The system as recited in claim 5, further comprising a flexible pivot about which the plurality of flexible elements are fixed, wherein the flexible pivot comprises the retractable slot formed therein, such that the retractable slot retractably spreads apart as fly-tying materials are wedged inside the retractable slot.

7. The system as recited in claim 1, wherein the retractable clamp table comprises a plurality of elements hingedly positioned about a pivot, such that the plurality of elements move about the pivot when retracting.

8. The system as recited in claim 7, further comprising an elastic restraint positioned about the gripping clamp, such that the gripping clamp is in a substantially closed position when the elastic restraint is relaxed.

9. The system as recited in claim 1, wherein any of the clamp table and the gripping clamp are composed of one of transparent and translucent materials.

10. The system as recited in claim 1, further comprising a wrapping cylinder about which dubbing can be wrapped, the wrapping cylinder configured to lay on an upper surface of the clamp table prior to inserting the dubbing inside the clamp table.

11. The system as recited in claim 1, further comprising a hook about which the one or more fly tying materials can be wrapped to form a fishing lure.

12. The system as recited in claim 1, further comprising a tying thread on which the one or more fly tying materials can be attached.

13. The system as recited in claim 1, wherein the one or more fly-tying materials comprise at least one of hackle, dubbing, and elongate synthetic fiber.

14. A method of processing fly-tying materials comprising:
inserting one or more fly-tying materials into a retractable slot of a retractable clamp table, such that at least a portion of the one or more fly-tying materials extends outward from the retractable slot;
gripping the at least a portion of the one or more fly-tying materials using a retractable gripping clamp.

15. The method as recited in claim 14, wherein the retractable clamp table comprises a resilient member having the retractable slot formed therein, and a substantially planar lower surface that supports the clamp table on a support surface.

16. The method as recited in claim 14, further comprising processing the one or more fly-tying materials such that the one or more fly-tying materials can be transferred from the retractable gripping clamp to a tying thread.

17. The method as recited in claim 14, further comprising attaching the one or more fly-tying materials to a tying thread using the retractable gripping clamp.

18. The method as recited in claim 17, further comprising splitting the tying thread along the length of the tying thread, such that the tying thread comprises an in-tact portion, and a split portion along its length; and inserting the one or more fly-tying materials inside the split portion.

19. The method as recited in claim 14, further comprising wrapping elongate material about a wrapping cylinder; and positioning the wrapping cylinder on an upper surface of the clamp table prior to inserting the one or more fly-tying materials into the retractable slot.

20. The method as recited in claim 19, further comprising cutting the elongate material that has been wrapped around the wrapping cylinder.

21. The method as recited in claim 20, wherein inserting one or more fly-tying materials comprises placing one of a hackle and a thread on top of the elongate material that has been cut, and pulling the one of a hackle and a thread into the retractable slot of the retractable clamp table.

22. A fly-tying kit comprising:
a clamp table having a plurality of first elements retractably positioned about a first pivot having a retractable first gap formed inside, wherein the plurality of first elements form an approximately planar surface when the retractable first gap is in an initial state, and wherein positioning one or more fly-tying materials into the retractable first gap causes the retractable slot to move to a subsequent state; and
a gripping clamp having a plurality of second elements retractably positioned about a second pivot having a retractable second gap, such that the plurality of second elements form a point when the retractable second gap is in an initial state.

23. The fly-tying kit as recited in claim 22, further comprising one or more wrapping cylinders about which one or more fly-tying materials can be wrapped.

24. The fly-tying kit as recited in claim 22, further comprising at least one of an instructional print medium, and an instructional optical medium.

25. The fly-tying kit as recited in claim 22, wherein the clamp table comprises any of foam rubber, and flexible plastic.

26. A clamp table comprising:
a resilient member having a retractable slot, wherein the retractable slot maintains a slight pressure between two opposing gripping surfaces for the purpose of permitting easy insertion and maintenance of fly-tying materials within the retractable slot.

27. A clamp table as recited in claim 26, wherein at least one of the gripping surfaces comprises at least one roller to facilitate insertion of the fly-tying materials within the retractable slot.

28. A clamp table as recited in claim 26, wherein the resilient member is positioned between two movable first and second elements, such that the two movable first and second elements extend from the two opposing gripping surfaces about the retractable slot.

29. A clamp table as recited in claim 26, wherein the resilient member is configured to rest in a stable position on a support surface when fly-tying materials have been positioned between the two opposing gripping surfaces.

30. A clamp table as recited in claim 26, wherein the clamp table comprises a resiliently flexible material including any of foam rubber, and flexible plastic.

31. A clamp table as recited in claim 30, wherein the retractable slot comprises an upper slit and a lower gap recess that is wider than the upper slit to facilitate insertion of the fly-tying materials within the retractable slot.

32. A retractable clamp table configured for use in tying flies to be used in fly-fishing, comprising:
a first element having a first gripping portion and a first leg portion;
a second element having a second gripping portion and a second leg portion; and
a resilient member configured to resiliently maintain the first gripping portion of the first element adjacent the second gripping portion of the second element, such that fly-tying materials can be selectively maintained between the first and second gripping portions, and such that a user can release the fly-tying materials by moving the first and second legs.

33. The retractable clamp table as recited in claim 32, wherein the first and second elements are configured to rest in a stable position on a support surface when the gripping portions are adjacent one another.

34. The retractable clamp table as recited in claim 32, wherein the first and second elements pivot with respect to each other.

35. The retractable clamp table as recited in claim 32, wherein the first and second elements comprise a foam material.

36. The retractable clamp table as recited in claim 35, wherein the resilient member comprises a foam material.

37. The retractable clamp table as recited in claim 32, wherein the resilient member comprises an elastic ring positioned about the first and second elements.

38. The retractable clamp table as recited in claim 32, wherein the resilient member comprises a flexible member positioned between the first and second elements.

39. The retractable clamp table as recited in claim 38, wherein the resilient member comprises a slotted foam material.

40. The retractable clamp table as recited in claim 38, wherein the resilient member comprises a resilient u-plate positioned between the first element and the second elements.

41. A retractable clamp table configured for use in tying flies to be used in fly-fishing, comprising:
a first element having a first gripping portion and a first leg portion; and
a second element having a second gripping portion and a second leg portion, the first element being connected to the second element, wherein the first and second elements define a retractable slot extending between the first and second elements, the retractable slot configured to receive fly-tying materials therein.

42. The retractable clamp table as recited in claim 41, wherein the retractable slot comprises an upper slit portion at an entry point of the first and second gripping portions for receiving fly-tying materials, and a gap at a base portion of the first and second gripping portions in which the fly-tying materials rest when inserted, the gap being larger than the upper slit portion.

43. The retractable clamp table as recited in claim 41, wherein the first and second gripping portions comprise a foam material.

44. The retractable clamp table as recited in claim 41, wherein the entire retractable clamp table comprises a resilient foam material.
